(19) United States
(12) Patent Application Publication
(10) Pub. No.: US 2012/0098912 A1
(43) Pub. Date: Apr. 26, 2012

(54) CONVEYING DEVICE OF RECORDING MEDIUM AND IMAGE FORMING APPARATUS

(75) Inventors: Yoshiaki Kaneko, Shizuoka-ken (JP); Kazuhiro Hara, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/274,447

(22) Filed: Oct. 17, 2011

Related U.S. Application Data
(60) Provisional application No. 61/405,838, filed on Oct. 22, 2010.

(51) Int. Cl. B41J 2/01; B65H 3/18

(52) U.S. Cl. 347/104; 271/18.1

(57) ABSTRACT

According to one embodiment, an image forming apparatus includes, an endless device which has a circumferential surface, a laminated cover which is arranged onto the circumferential surface of the endless device in an overlapping manner, a rotation mechanism which rotates the endless device, a supply mechanism which supplies a recording medium to the endless device, a recording head unit, and a discharge mechanism. The laminated cover include a metal layer which has the inner surface which comes into contact with the circumferential surface of the endless device, and a dielectric layer which comes into contact with the metal layer. The laminated cover includes a hem portion which is formed to be folded back at least at a part of a circumferential edge region of the laminated cover, with the dielectric layer as the outside of the bending.

### CROSS-REFERENCE TO RELATED APPLICATIONS

This application is based upon claims the benefit of priority from: U.S. Provisional Application No. 61/405,838 filed on Oct. 22, 2010, the entire contents of each of which are incorporated herein reference.

### FIELD

Embodiments described herein relate generally to a conveying device of a recording medium which conveys a recording medium such as a sheet, and an image forming apparatus.

### BACKGROUND

For example, an inkjet printer (an inkjet recording apparatus) or the like, includes an endless device which is formed of a rotatable drum, and a recording head unit which is disposed along a circumferential surface of the endless device. The recording medium is adsorbed to the circumferential surface of the endless device, and is conveyed to the recording head unit, when the endless device rotates. An example of the endless device is a drum which has a dielectric layer on the circumferential surface thereof. The recording medium is adsorbed to the drum due to an electrostatic force, when the dielectric layer of the drum is charged. The rotating drum functions as a conveying device.

A drum is known in which the circumferential surface thereof is arranged with a laminated cover which is formed of a metal layer and a dielectric layer. In the related art, there may be a case where creeping discharge occurs on the circumferential edge of the laminated cover. When a charge of the dielectric layer flows into the metal layer due to the creeping charge, the recording medium is easily separated from the drum, since an adsorption force reduces due to static electricity.

### BRIEF DESCRIPTION OF THE DRAWINGS

FIG. 1 is a side view which schematically shows the inside of an image forming apparatus according to a first embodiment.

FIG. 2 is a side view which shows an enlarged part of the image forming apparatus.

FIG. 3 is a perspective view which shows a drum unit according to the first embodiment.

FIG. 4 is a cross-sectional view which schematically shows a part of the drum unit and a charge.

FIG. 5A is a cross-sectional view which shows a circumferential region of a laminated cover before being folded back.

FIG. 5B is a cross-sectional view which shows the circumferential region of the laminated cover in the middle of being folded back.

FIG. 5C is a cross-sectional view which shows a hem portion formed on the laminated cover.

FIG. 6 is a cross-sectional view which schematically shows a part of the drum unit and a charge.

FIG. 7 is a cross-sectional view which shows a part of the drum unit and a separation member.

FIG. 8 is a cross-sectional view which shows a part of the drum unit according to a second embodiment.

FIG. 9 is a cross-sectional view which shows a part of the drum unit according to a third embodiment.

FIG. 10 is a perspective view which shows a drum unit according to a fourth embodiment.

FIG. 11 is a perspective view which shows a drum unit according to a fifth embodiment.

FIG. 12 is a side view which schematically shows an image forming apparatus according to a sixth embodiment.

### DETAILED DESCRIPTION

In general, according to one embodiment, an image forming apparatus includes, an endless device which has a circumferential surface, and rotates in the circumferential direction; a laminated cover which is disposed at the circumferential surface of the endless device, in an overlapping manner; a rotation mechanism which allows the endless device to rotate around an axis; a supply mechanism which supplies a recording medium to the endless device; a charging roller which charges the dielectric layer of the laminated cover; a recording head unit which forms an image to the recording medium; a separation mechanism which separates the recording medium on which the image is formed, from the dielectric layer; and a discharge mechanism which discharges the recording medium which is separated from the dielectric layer. The laminated cover includes a metal layer which has the inner surface that comes into contact with the circumferential surface of the endless device, and a dielectric layer which comes into contact with the metal layer. Further, the image forming apparatus includes a hem portion which is formed to be folded back at least at a part of a circumferential edge region of the laminated cover, with the dielectric layer as the outside of the bending.

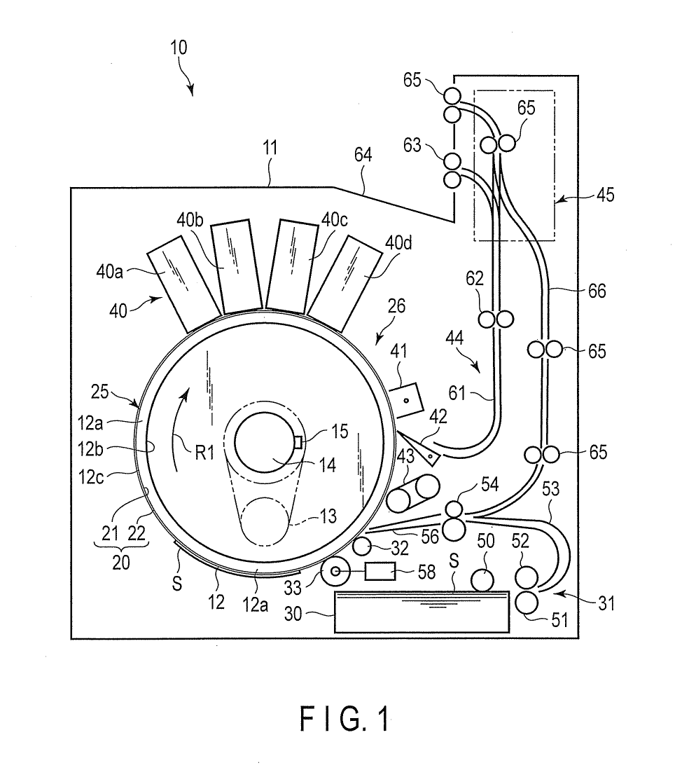

Hereinafter, an image forming apparatus according to a first embodiment will be described with reference to FIGS. 1 to 7. FIG. 1 shows an inkjet printer 10 which is an example of the image forming apparatus. The inkjet printer 10 (hereinafter, referred to as a printer) includes a housing 11, a drum 12 which is accommodated in the housing 11, and is an example of an endless device, and a rotation mechanism 13 which includes a motor which allows the drum 12 to rotate.

The drum 12 has a cylinder portion 12a, and rotates at a predetermined circumferential speed in the direction shown by an arrow R1, around an axial member 14, using the rotation mechanism 13. The position of the drum 12 in the rotational direction is detected using a rotation angle sensor 15 such as an encoder. The drum 12 is formed of a synthetic resin with electric insulation, and has an inner circumferential surface 12b and outer circumferential surface 12c.

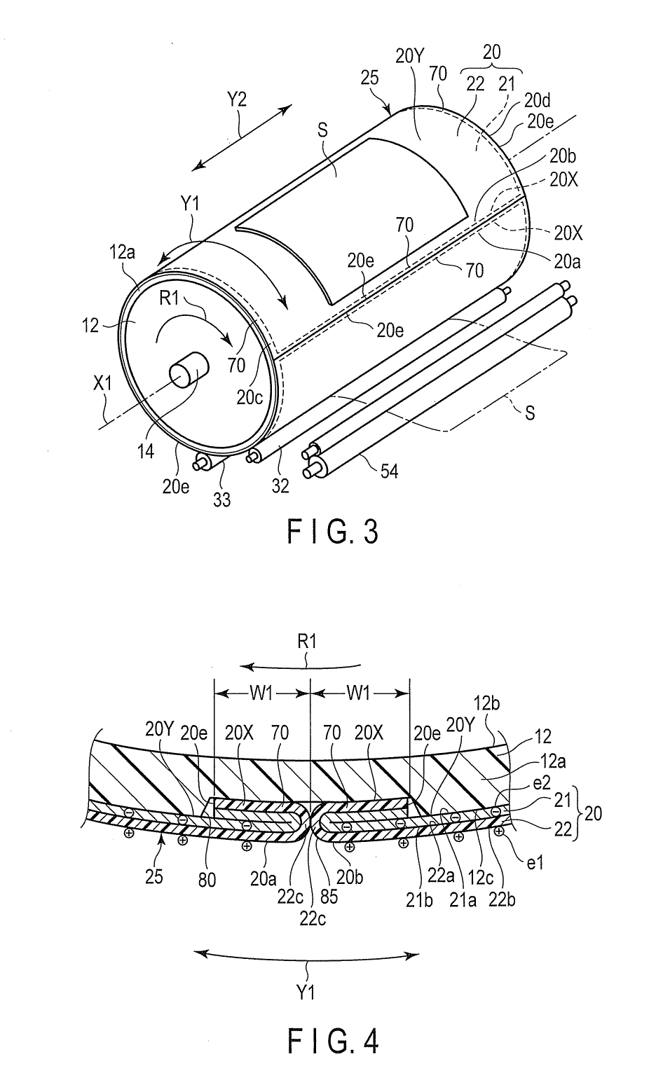

A laminated cover 20 which is formed of a metal later 21 and a dielectric layer 22, is disposed at the circumferential surface 12c of the drum 12. The laminated cover 20 is fixed to the outer circumferential surface 12c of the drum 12 using an adhesive, or the like. For this reason, the drum 12 and the laminated cover 20 integrally rotate around the axial member 14. A drum unit 25 which rotates around an axis X1 (shown in FIG. 3) of the drum 12, is configured by these drum 12 and laminated cover 20. The rotatable drum unit 25 functions as a conveying device 26 for conveying a sheet S. The laminated cover 20 will be described in detail later.

In addition, the printer 10 includes a sheet receiving unit 30, a sheet supply mechanism 31, a push roller 32, a charging roller 33, a recording head unit 40, a neutralizing charger 41, a separation member 42, a cleaner 43, a discharging mechanism 44, a reversing mechanism 45, and the like. The cleaner 43 cleans the circumferential surface of the drum unit 25. The neutralizing charger 41 and the separation member 42 configure a separation mechanism which separates the sheet S from the drum unit 25. The charging roller 33 or the separation member 42 and the cleaner 43 includes a movement mechanism for separating the member and units from the sheet S, in order not to come into contact with the image surface of the sheet S when the sheet S on which images are formed, is passing through.

The sheet receiving unit 30 receives a plurality of sheets S as a recording medium. An example of the sheet S is paper with a defined size, however, it may be a resin film, a label, or the like. The sheet supply mechanism 31 includes a pick-up roller 50, a sheet feeding roller 51, a separation roller 52, a sheet conveying path 53, and a pair of resist rollers 54. The sheet S which is extracted one by one using the sheet feeding roller 51 and the separation roller 52, is sent to the sheet conveying path 53. The leading end of the sheet S which is sent to the sheet conveying path 53, is aligned using the pair of resist rollers 54. A guide 56 for guiding the sheet S is provided between the pair of resist rollers 54 and the drum unit 25.

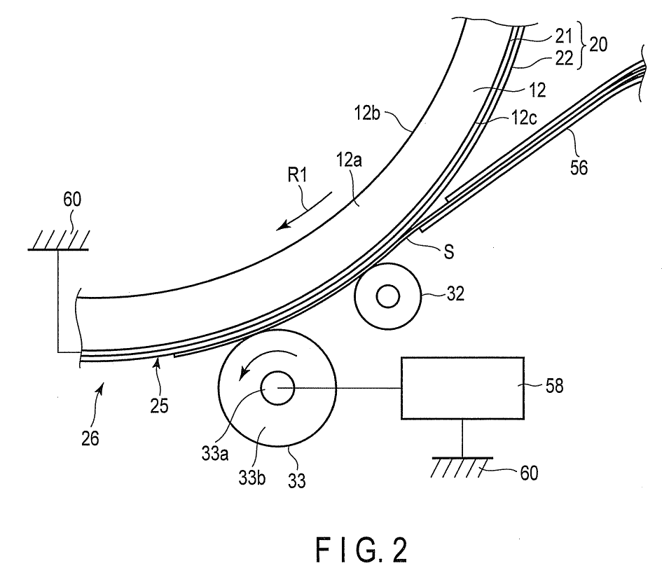

FIG. 2 shows a part of the drum unit 25, the push roller 32, the charging roller 33, and the like. The charging roller 33 is arranged to face the dielectric layer 22 of the drum unit 25. The charging roller 33 is formed of a mandrel 33a formed of metal, and a conductor 33b which is formed of a conductive material such as conductive rubber which is provided at the outside of the mandrel 33a. A power circuit 58 is connected to the mandrel 33a. A DC voltage (for example, several thousands of volts) is applied to the charging roller 33 through the power circuit 58.

The metal layer 21 of the laminated cover 20 is grounded to a ground 60. A charge e1 (schematically shown in FIG. 4) with a first polarity is charged to the outer surface of the dielectric layer 22, using the charging roller 33. A charge e2 with a second polarity is charged to the metal layer 21 which functions as a counter electrode. In this manner, a potential of each portion of the laminated cover 20 is maintained at 0 V.

An example of the recording head unit 40 includes inkjet heads for each color, 40a, 40b, 40c, and 40d which can perform color printing using water-based ink. All of these inkjet heads 40a, 40b, 40c, and 40d are line heads which extend in the direction of axis X1 of the drum 12 (shown in FIG. 3). The inkjet heads 40a, 40b, 40c, and 40d according to the embodiment include a plurality of nozzle holes (not shown) for ejecting water-based ink. In addition, inkjet heads which use oil-based ink may be used.

An example of inkjet heads 40a, 40b, 40c, and 40d includes the piezo element as a driving member. When a voltage is applied to the piezo element, the piezo element is deformed, and when ink is pressurized, the ink is ejected from the nozzle holes. In addition, as another example of the driving member, a heating element may be used. When the ink is heated using the heating element, the ink is ejected from the nozzle holes due to a pressure of bubble which is generated when ink is vaporized.

The discharge mechanism 44 includes a conveying guide 61, conveying rollers 62, discharging rollers 63, and a discharge tray 64. The reversing mechanism 45 includes reversing rollers 65 which reverses the sheet S, a reversing path 66, or the like.

FIG. 3 shows the drum unit 25 which has the drum 12 and the laminated cover 20, the push roller 32, the charging roller 33, and the pair of resist rollers 54. The drum unit 25 is configured by the drum 12 and the laminated cover 20. In FIG. 3, an arrow Y1 shows the circumferential direction of the drum 12. The direction goes along the axis X1 of the drum 12 (the direction shown by an arrow Y2) is the width direction of the drum 12, that is, the width direction of the endless device.

The laminated cover 20 is overlapped with the circumferential surface 12c of the cylinder portion 12a of the drum 12, and is fixed using the adhesive. The laminated cover 20 has both end portions 20a and 20b in the circumferential direction Y1 of the drum 12, both side portions 20c and 20d which forms a right angle) (90°) with respect to both of the end portions 20a and 20b, and a circumferential edge 20e. The circumferential edge 20e is widespread in the entire circumference of the laminated cover 20, that is, both the end portions 20a and 20b, and both the side portions 20c and 20d. The laminated cover 20 includes a circumferential edge region 20X which includes the circumferential edge 20e and an inside main region 20Y which is surrounded by the circumferential edge region 20X.

The laminated cover 20 includes the metal layer 21 which is formed of, for example, aluminum and a dielectric layer 22 which is arranged at the metal layer 21 in the thickness direction in an overlapping manner. The metal layer 21 has an inner surface 21a which comes into contact with the circumferential surface 12c of the drum 12, and an outer surface 21b which is reverse side of the inner surface 21a. The dielectric layer 22 is formed of a resin film such as, for example, poly fluoroehtylene or PET (Poly ethylene terephthalate). The dielectric layer 22 has an inner surface 22a which comes into contact with the outer surface 21b of the metal layer 21, and an outer surface 22b which is the surface of the drum unit 25. The thickness of the metal layer 21 and the dielectric layer 22 are respectively, for example, 0.1 to 0.3 mm, however, the thickness is not limited thereto, since the respective thicknesses are selected according to a specification of the drum unit 25. The area of the dielectric layer 22 is the same as that of the metal layer 21.

FIG. 4 shows a vicinity of both end portions 20a and 20b in the circumferential direction Y1 of the laminated cover 20. In both the end portions 20a and 20b of the laminated cover 20, the circumferential edge region 20X is folded back by only the width W1 so that the dielectric layer 22 becomes the outside of the bending. The hem portion 70 is formed by overlapping the circumferential edge region 20X which is folded back, with the main region 20Y of the laminated cover 20. The hem portion 70 is formed over approximately the entire length of the drum 12 along the axis X1 of the drum 12.

A concave portion 80 which extends to the drum 12 in the axial direction (direction along the axis X1), is formed on the circumferential surface 12c of the drum 12. The hem portion 70 is disposed at the concave portion 80, and the hem portion 70 is fixed to the circumferential surface 12c of the drum 12 using the adhesive, or the like, according to the embodiment. Since the hem portion 70 is accommodated in the concave portion 80, it is possible to prevent the hem portion 70 from protruding to the outside of the drum unit 25. For this reason, it is possible to prevent the hem portion 70 from coming into contact with the charging roller 33, the separation member 42, the cleaner 43, or the like, when the drum unit 25 rotates in the direction of the arrow R1.

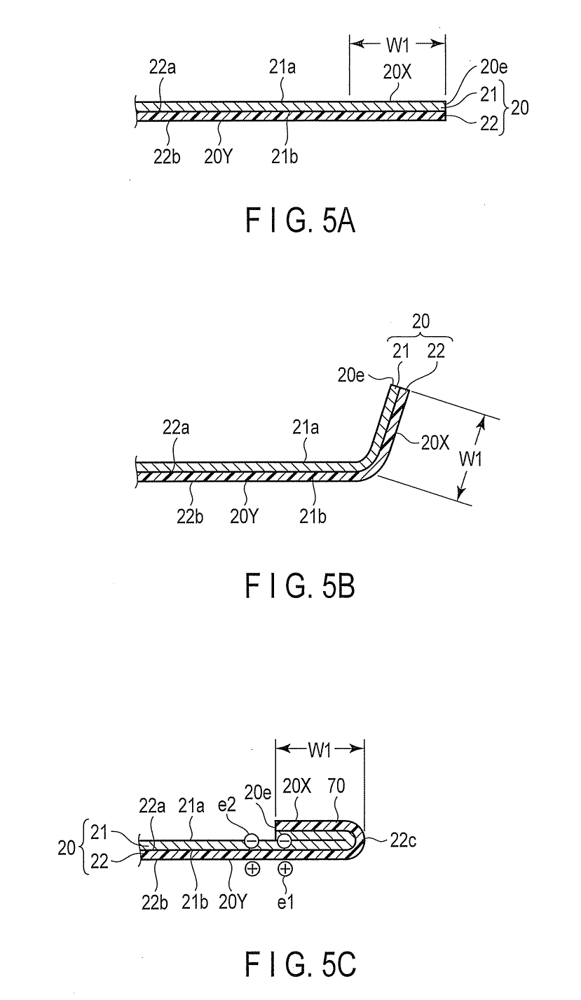

FIGS. 5A, 5B, and 5C schematically show a procedure in which the hem portion 70 is formed. FIG. 5A shows a state before the circumferential edge region 20X of the laminated cover 20 is folded back. As shown in FIG. 5B, the circumferential edge region 20X of the laminated cover 20 is folded back by the width W1. As shown in FIG. 5C, the hem portion 70 is formed, when the circumferential edge region 20X of the laminated cover 20 which is folded back is overlapped with the main region 20Y of the laminated cover 20. The circumferential edge region 20X is fixed to the main region 20Y using the adhesive.

In the hem portion 70, the circumferential edge portion of the metal layer 21 is covered with the circumferential edge portion of the dielectric layer 22, which serves as an insulator. For this reason, it is possible to suppress the movement of the charge e1 which is charged to the dielectric layer 22, to the metal layer 21 by the outside of the hem portion 70 and the dielectric layer 22 in the inside. As a result, the creeping discharge is suppressed.

In addition, a semicircular arc portion 22c which is a part of the dielectric layer 22, is formed between the dielectric layer 22 on the outside of the hem portion 70 and dielectric layer 22 in the inside. As shown in FIGS. 4 and 7, the semicircular arc portion 22c includes a slope 85 of an arc shape which faces the outer surface of the drum unit 25. The slope 85 is sloped so that the distance from the circumferential surface 12c of the drum 12 becomes wide from the front side to the rear side of the drum 12 in the rotation direction. Due to the slope 85, it is possible to prevent a tip of the separation member 42 from being hooked to an end surface of the dielectric layer 22.

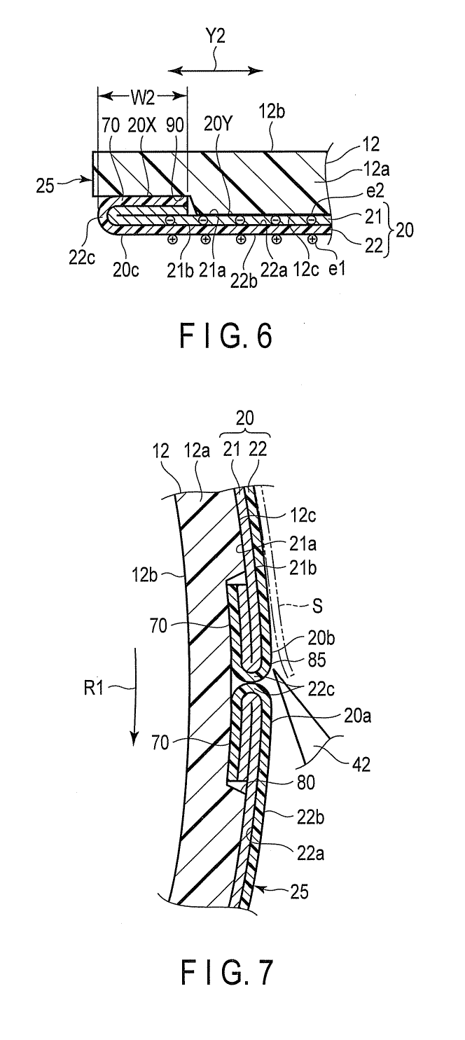

FIG. 6 representatively shows one side portion 20c between both side portions 20c and 20d of the laminate cover 20. The other side portion 20d has the same configuration as that of the side portion 20c. In this portion, the circumferential edge region 20X of the laminated cover 20 is folded back by the size W2 so that the dielectric layer 22 becomes the outside of the bending, and is overlapped with the main region 20Y of the laminated cover 20, thereby forming the hem portion 70. The hem portion 70 is continuously formed in the circumferential direction Y1 of the drum 12.

Respective concave portions 90 are formed at both ends of the drum 12 in the direction of the axis X1. The concave portion 90 is continuously formed in the circumferential direction Y1 of the drum 12. The hem portion 70 is disposed at the concave portion 90, and is fixed to the drum 12 using the adhesive, or the like. The creeping discharge is suppressed in both the side portions 20c and 20d of the laminated cover 20, due to the hem portion 70.

Hereinafter, an outline of the printing process using the printer 10 will be described.

The sheet S which is conveyed to the pair of resist rollers 54 using the sheet supply mechanism 31 from the sheet receiving unit 30, is temporally stopped due to the pair of resist rollers 54. After the leading end position of the sheet S is aligned using the pair of resist rollers 54, the pair of resist rollers 54 rotate again. In this manner, the sheet S is supplied to the charging roller 33 through the push roller 32.

The sheet S is pinched between the drum unit 25 and the charging roller 33. A DC voltage is applied to the charging roller 33 through the power circuit 58. When the charging roller 33 comes into contact with the surface of the sheet S, a charge with the first polarity is charged to the outer surface of the sheet S, and a charge with the second polarity is charged to the inner surface of the sheet S. Further, a charge with the first polarity is charged to the outer surface 22b of the dielectric layer 22, and a charge with the second polarity is charged to the inner surface 22a of the dielectric layer 22. Due to these polarization charges, the sheet S is electrostatically adsorbed to the surface of the dielectric layer 22.

The sheet S moves in the rotation direction R1 of the drum 12, along with the drum 12. When performing color printing, if the sheet S reaches the first inkjet head 40a, the first color ink is ejected to the sheet S from the first inkjet head 40a. If the sheet S rotates while being adsorbed to the drum 12, and reaches the second inkjet head 40b, the second color ink is ejected from the second inkjet head 40b toward the sheet S. Further, when the drum 12 rotates, the third color ink is ejected to the sheet S from the third inkjet head 40c. In addition, when the drum 12 rotates, the fourth color ink is ejected to the sheet S from the fourth inkjet head 40d. In this manner, an image is formed on the sheet S while the drum 12 rotates. That is, the printer 10 performs color printing using a multi-pass system of a line head-type.

When the printing ends, an AC voltage is applied to the sheet S on which the image is formed, using the neutralizing charger 41. In this manner, the adsorption force of the sheet S with respect to the dielectric layer 22 is reduced. The sheet S is separated from the drum unit 25 using the separation member 42, and is discharged onto the discharge tray 64 through the conveying guide 61 and the discharge rollers 63.

As shown in FIG. 7, it is considered that the tip of the separation member 42 comes into contact with the hem portion 70 of the laminated cover 20, when the sheet S is separated using the separation member 42. However, since the slope 85 is formed in the hem portion 70, it is possible to prevent the tip of the separation member 42 hooking to an end surface of the dielectric layer 22.

When performing double-sided printing, a first surface of the sheet S which is conveyed as the outer surface, is formed with an image using the recording head unit 40, and then the sheet S is reversed using the reversing mechanism 45. The sheet S is conveyed again with a second surface as the outer surface, using the drum unit 25, and the image is formed on the second surface using the recording head unit 40.

The laminated cover 20 of the drum unit 25 according to the embodiment has the respective hem portions 70 on the entire circumference thereof (both end portions 20a, 20b and both side portions 20c, 20d). For this reason, the creeping discharge in which the charge which is charged to the dielectric layer 22 moves to the metal layer 21, is suppressed, and it is possible to prevent the adsorption force due to the static electricity from being decreased. Accordingly, it is possible to reliably hold the sheet S to the drum unit 25, even if the drum unit 25 rotates.

If the sheet S absorbed moisture due to the ink ejected to the sheet S from the recording head unit 40, a bending stress occurs in the sheet S. Even such a sheet S can be stably and reliably held due to the electrostatic force of the drum unit 25. For this reason, it is possible to perform an image formation of high quality at high speed, and to prevent paper jamming.

In a case of a recording head unit 40 which eject water-based ink, since the water-based ink is a conductor, the inside of the housing 11 has an environment in which the creeping discharge easily occurs. Specifically, in the sheet on which the double-sided printing is performed, the first and second surfaces are reversed while the water-based ink on the surface of the image is not sufficiently dried up, whereby the image surface comes into contact with the dielectric layer 22. For this reason, there is a possibility of the creeping charge being aggravated. However, according to the embodiment, since the laminated cover 20 has the hem portion 70, it is possible to effectively prevent the creeping charge from occurring even when the double-sided printing using the water-based ink is performed.

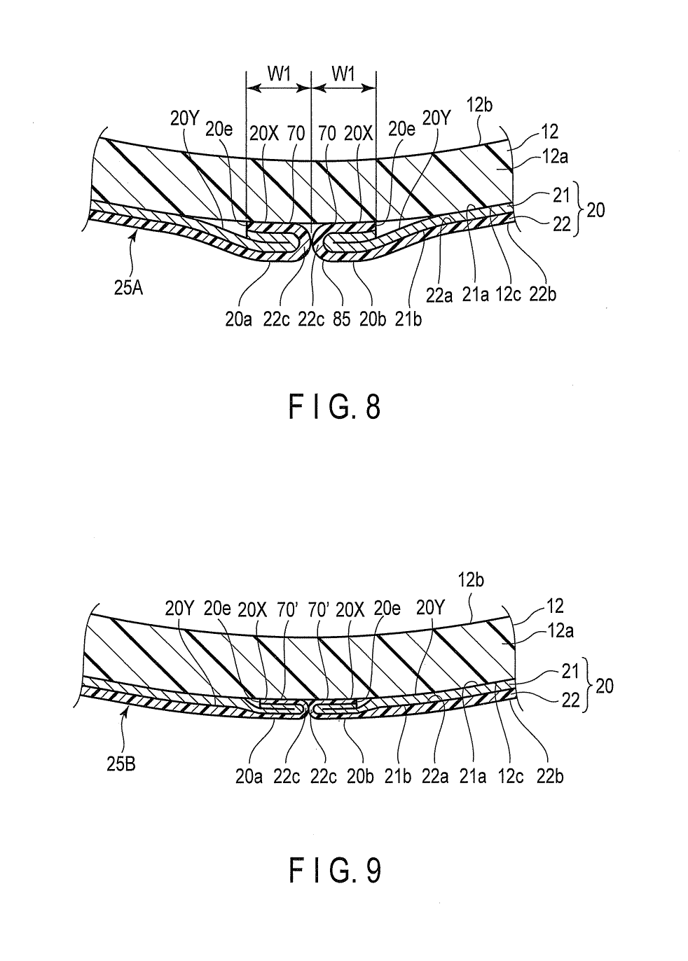

FIG. 8 shows a part of the drum unit 25A according to a second embodiment. The drum unit 25A fixes a hem portion 70 to a circumferential surface 12c of a drum 12, using an adhesive or the like, without forming a concave portion to the circumferential surface 12c of the drum 12. Since the drum unit 25A has the same configuration and operation as those of the drum unit 25 of the first embodiment, common configuration and operation will be denoted by the same reference numerals, and descriptions thereof will be omitted.

FIG. 9 shows a part of the drum unit 25B according to a third embodiment. In a laminated cover 20 of the drum unit 25B, the thickness of a circumferential edge region 20X is smaller than that of a main region 20Y. The thickness of the circumferential edge region 20X is approximately half the thickness of the main region 20Y. A hem portion 70′ is formed by folding back the circumferential edge region 20X. According to this configuration, it is possible to prevent the hem portion 70′ from protruding to the circumferential surface of the drum unit 25, without forming the concave portion 80 to the drum 12. Since the drum unit 25B has the same configuration and operation as those of the drum unit 25 of the first embodiment, common configuration and operation will be denoted by the same reference numerals, and descriptions thereof will be omitted.

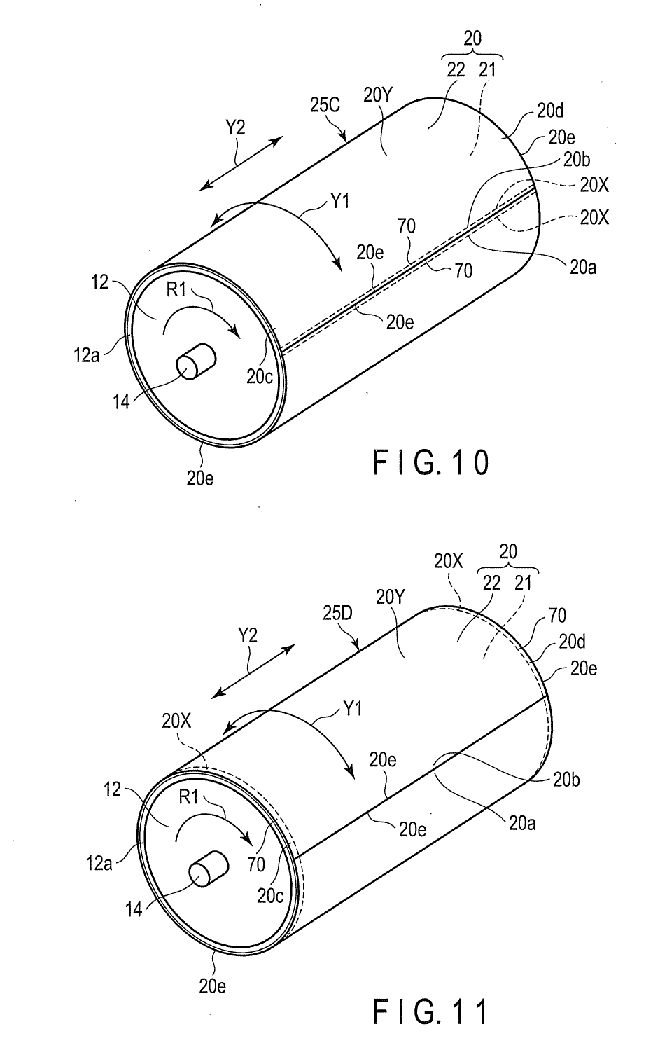

FIG. 10 is a perspective view of a drum unit 25C according to a fourth embodiment. A laminated cover 20 according to the embodiment has a hem portion 70 only at both end portions 20a and 20b, in the circumferential direction Y1 of a drum 12. Since the drum unit 25C has the same configuration and operation as those of the drum unit 25 of the first embodiment, common configuration and operation will be denoted by the same reference numerals, and descriptions thereof will be omitted.

FIG. 11 is a perspective view of a drum unit 25D according to a fifth embodiment. A laminated cover 20 according to the embodiment has a hem portion 70 only at both side portions 20c and 20d. Since the drum unit 25D has the same configuration and operation as those of the drum unit 25 of the first embodiment, common configurations and operation will be denoted by the same reference numerals, and descriptions thereof will be omitted.

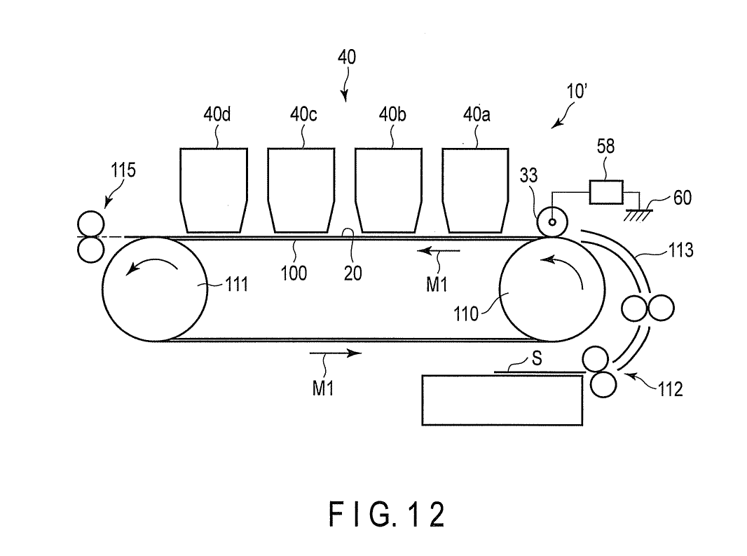

FIG. 12 shows an inkjet printer 10′ according to a sixth embodiment. The inkjet printer 10′ includes an endless device which is formed of a belt 100, and a laminated cover 20 which is provided on the outer circumferential surface of the belt 100. Similarly to the above described each of the embodiments, the laminated cover 20 includes a metal layer and dielectric layer. In addition, the laminated cover 20 has the same hem portion as that of the above described each of the embodiments, at least at a part of the entire circumference of the laminated cover 20. Due to the hem portion, the creeping discharge of the dielectric layer is suppressed. A belt 100 is extended between a first rotation body 110 and a second rotation body 111, and performs a rotation movement (circulating movement) in the direction shown by an arrow M1, using a driving mechanism (not shown). A charging roller 33 or a recording head unit 40 is arranged along the movement direction M1 of the belt 100. A power circuit 58 for applying a DC voltage is connected to the charging roller 33. The sheet S is supplied between the laminated cover 20 of the belt 100 and the charging roller 33 through a conveying path 113, from a supply mechanism 112. The charging roller 33 applies a polarization charges for electrostatically adsorbing, to the dielectric layer of the laminated cover 20 and the sheet S. On the sheet S, an image is formed using inkjet heads 40a, 40b, 40c, and 40d, while being conveyed in a direction shown by the arrow M1, using the belt 100. The sheet S on which the image is formed, is discharged from a conveying mechanism 115.

As described above, in the printer according to the above described each embodiments, it is possible to stably and reliably adsorb the sheet onto the circumferential surface of the endless device, since it is possible to suppress the creeping discharge using the hem portion which is formed on the laminated cover. The above described embodiments can be applied to an image forming apparatus such as a thermal printer or a wire dot printer, including the inkjet printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A conveying device of a recording medium comprising:
an endless device which has a circumferential surface, and rotates in a circumferential direction around an axis; and
a laminated cover arranged onto the circumferential surface of the endless device in an overlapping manner, the laminated cover comprising a metal layer which has an inner surface which comes into contact with the circumferential surface of the endless device, a dielectric layer which comes into contact with the metal layer, and a hem portion which is formed to be folded back at least at a part of a circumferential edge region of the laminated cover, with the dielectric layer as the outside of bending.

2. The device according to claim 1,
wherein the laminated cover has both end portions and both side portions in the circumferential direction of the endless device, and the hem portion at both the end portion.

3. The device according to claim 2,
wherein a pair of hem portions which is formed at both the end portion is fixed to the circumferential surface of the endless device in a state where the pair of hem portions is facing each other.

4. The device according to claim 3,
wherein the endless device has a concave portion which goes along the axis, on the circumferential surface, and
wherein the pair of hem portions is arranged at the concave portion.

5. The device according to claim 1,
wherein the laminated cover has both end portions and both side portions in the circumferential direction of the endless device, and has the hem portion at both the side portions.

6. The device according to claim 5,
wherein the concave portion which goes along the circumferential direction is defined at the circumferential surface of the endless device, and
wherein the hem portion of the side portion is arranged at the concave portion.

7. The device according to claim 1,
wherein the laminated cover has both end portions and both side portions in the circumferential direction of the endless device, and the hem portion respectively at both the end portions and both the side portions.

8. The device according to claim 1,
wherein the laminated cover has the circumferential edge region and a main region which is surrounded by the circumferential edge region, in which the thickness of the circumferential edge region is smaller than that of the main region, and the hem portion is formed by folding back the circumferential edge region.

9. The device according to claim 1,
wherein the endless device is a drum with a cylinder portion, and the laminated cover is arranged onto a circumferential surface of the cylinder portion of the drum.

10. The device according to claim 9,
wherein the endless device is a belt, and the laminated cover is arranged onto a circumferential surface of the belt.

11. An image forming apparatus comprising:
an endless device which has a circumferential surface;
a laminated cover arranged onto the circumferential surface of the endless device in an overlapping manner, the laminated cover comprising a metal layer which has an inner surface which comes into contact with the circumferential surface of the endless device, a dielectric layer which comes into contact with the metal layer, and a hem portion which is formed to be folded back at least at a part of a circumferential edge region of the laminated cover, with the dielectric layer as the outside of bending;
a rotation mechanism which rotates the endless device in a circumferential direction around an axis;
a supply mechanism which supplies a recording medium to the endless device;
a charging roller which charges the dielectric layer of the laminated cover with a charge which adsorbs the recording medium to the dielectric layer;
a recording head unit which forms images on the recording medium;
a separation mechanism which separates the recording medium on which the images are formed, from the dielectric layer; and
a discharge mechanism which discharge the recording medium which is separated from the dielectric layer.

12. The apparatus according to claim 11,
wherein the recording head unit has an inkjet head which ejects water-based ink to the recording medium.

13. The apparatus according to claim 12, further comprising:
a reversing mechanism which reverses first and second surfaces of the recording medium on which images are formed using the inkjet head, and supplies the recording medium to the endless device again.

14. The apparatus according to claim 11,
wherein the separation mechanism includes a neutralizing charger which neutralizes a charge on the recording medium, and a separation member which separates the recording medium which is neutralized using the neutralizing charger, from the dielectric layer.

15. The apparatus according to claim 11,
wherein the laminated cover has both end portions and both side portions on the circumferential direction of the endless device, and the hem portion on both the end portion.

16. The apparatus according to claim 15,
wherein a concave portion which goes along the axis, is defined on the circumferential surface of the endless device,
wherein the pair of hem portions is arranged to the concave portion.

17. The apparatus according to claim 15,
wherein the hem portion has a slope which is inclined so that a distance from the circumferential surface of the endless device increases from the front side to the rear side of the endless device, in the rotation direction.

18. The apparatus according to claim 15,
wherein the laminated cover includes the circumferential edge region and a main region which is surrounded by the circumferential edge region, and
wherein the thickness of a circumferential edge region is smaller than that of the main region, and the hem portion is formed by folding back the circumferential edge region.

19. The apparatus according to claim 11,
wherein the laminated cover has both end portions and both side portions in the circumferential direction of the endless device, and respectively has the hem portion at both the end portion and both the side portion.
